(19) United States
(12) Patent Application Publication
(10) Pub. No.: US 2007/0161412 A1
(43) Pub. Date: Jul. 12, 2007

(54) Augmentation of ringtones and other signals

(76) Inventors: Jeffrey S. Nevid, New York, NY (US); Spencer A. Rathus, Sag Harbor, NY (US)

Correspondence Address: Ward & Olivo;Suite 410, 382 Springfield Avenue, Summit, NJ, 07901, US

(21) Appl. No.: 11/328,825

(22) Filed: Jan. 10, 2006

(51) Int. Cl. H04B 1/38

(52) U.S. Cl. 455/567; 455/403

(57) ABSTRACT

The present invention is directed to a system and method for providing calling parties the ability to augment, modify, or supplement ringtones or other signals annunciated at a called station. Users interact with the system to allow for modifications of the network service. At the same time, users are given the ability to signal call recipients regarding the importance of an incoming call or the content of the call, or to communicate a calling party's moods, thoughts, needs, or states of mind.

### FIELD OF THE INVENTION

The invention relates generally to the field of wireless communication, and more specifically, to a wireless communications system and method which permits calling parties to augment, modify, or supplement ringtones or other signals annunciated at a called station. A calling party associates a particular call status indication with an outgoing call. This call status indication is received by the called station and results in the augmentation, modification, or supplementation of the ringtone or other signal annunciated on the called station.

### BACKGROUND OF THE INVENTION

Today, several enhanced communications station features allow users to personalize their communication experience. For example, users of a communications station may send Short Messaging Service (SMS) or Multimedia Messaging Service (MMS) messages containing custom graphics, photographs, audio, and video to personalize their messages. In addition, with the integration of wireless telephony with data services, such as the Internet, wireless and cellular telephone users can receive or download personalized wallpaper, screensavers, and themes to personalize telephone stations and make the stations look and feel more user-friendly. Users may even customize the communications stations with background images, including pictures taken by the user (perhaps using a camera integrated with the user's communications station) to further personalize the communications experience.

However, the personalized feature that draws the most attention for wireless telephone users is the ability to utilize custom ringtones. Ringtones are short music and/or video clips that are displayed or played when an incoming call is received, but before the call is answered. These custom ringtones take the place of the traditional “ring, ring” sound conventionally heard when a called station receives an incoming call. These custom ringtones may be downloaded from a network resource, such as the Internet or a network storage device, or they may be created by the user of the called communications station and stored or uploaded to memory within the communications station or network location.

The range of distinctive ringtones, which typically carry a modest fee if downloaded, extends to variations on standard rings to popular music, theme songs, sound effects, and even humorous vocalizations featuring favored television or movie characters. Users can even assign particular ringtones to specific callers or groups of callers. This allows the ability for a user of a called station to identify who is calling before answering the call or glancing at a caller identification display.

Systems for selecting distinctive ringtones and other personal tones are well known in the art. For example, U.S. Pat. No. 5,687,227 to Cohrs et al., U.S. Pat. No. 6,317,484 to McAllister, U.S. Pat. No. 5,661,788 to Chin, U.S. Patent Application Publication No. 20020115456 to Narinen, and U.S. Patent Publication No. 20040032946 to Koser et al. disclose various ringtone delivery, playback, and selection systems.

In yet another example, U.S. Pat. No. 6,418,330 to Lee specifies a means for selecting and generating ringtones from a ringtone storage device or by downloading ringtones from a database. Additionally, telephone subscribers can select a distinctive ringtone for each directory telephone number (or calling party number) from a plurality of available rings.

U.S. Pat. No. 6,819,945 to Chow et al. (hereinafter referred to as “Chow”) discloses the designation of particular ringtones for directory numbers representing personal calls, business calls, or important calls. In addition, Chow discloses a separate selection of ringtones for blocked calls (i.e. for all calls originating from parties who have blocked their number pursuant to call blocking). U.S. Pat. No. 5,636,269 to Eisdorfer and U.S. Pat. No. 6,704,405 to Farris et al. disclose systems for personalizing waiting tones by providing a distinctive call waiting tone or voice message that discloses a calling party's identity or the importance of the call. In U.S. Pat. No. 6,438,216 to Atkas, a system is disclosed for displaying a caller-specified message containing content-specific information relating to the subject matter of interest to a calling party on a targeted called party's telephone.

Systems also exist for using tones to alert a called party that an incoming call has been placed from a particular directory number, as in U.S. Pat. No. 6,778,648 to Alston et al. Similarly, in U.S. Pat. No. 6,813,344 to Lemke, different ringtones can be used to indicate that a call is received from a cellular phone as opposed to a land line. Moreover, since users often become tired of repetitive ringtones, systems exist for simplifying the ringtone selection process. For example, U.S. Pat. No. 6,675,026 to Yoon discloses a system for varying the terminating ringtone for each incoming call by drawing upon a plurality of stored melodies according to some sequence specified by the user.

In U.S. Patent Publication No. 20040081305 to Gonzalez et al. (hereinafter referred to as “Gonzalez”), a method is disclosed for substituting a user's ringtone with a distinctive ringtone keyed to a particular type of call requested by the caller (e.g., urgent, routine, emergency, etc.). However, the system described in Gonzalez requires callers to respond to prompts initiated by the telephone service provider in order to identify the type of call to be placed. The use of an intermediary step can be time consuming and cumbersome, which may lead callers to avoid using the service. Moreover, a principal drawback of the techniques disclosed by Gonzalez is that it does not provide a means by which the called party could identify the source of the call before answering it. For example, the Gonzalez system allows each subscriber to specify a list of call types, whereby the system delivers or plays the ringtone designated by the subscriber for all incoming calls of the corresponding type. Thus, callers who type their incoming calls in the same way cause the same ringtone to be annunciated on the called station. In addition, Gonzalez only discloses the selection and annunciation of a designated ringtone and does not disclose the augmentation or modification of a ringtone once it has been designated.

Typically, wireless communications devices, including many wireless and cellular telephones, play a selected ringtone or other signals, such as vibration modes (sometimes called “manner” or silent mode of operation) upon receipt of an incoming call. The user can further personalize their calling experience by associating a designated ringtone or other signal with some or all incoming calling stations. However, calling parties have no control over the presentation of ringtones or other signals generated on a called party's telephone. For example, a wireless or cellular telephone user might designate a particular ringtone to play for certain incoming callers. For instance, the user might select the theme music from the movie “Mission Impossible” to play whenever an incoming call from a friend's telephone number or network address is received. Once the ringtone is associated with the friend's telephone number or network address, the ringtone plays exactly the same way each time an incoming call is received from that telephone number or network address. The same ringtone is played until the user of the called station changes the ringtone associated with the friend's telephone number or network address to a new ringtone (or reverts to a conventional ringtone).

Presently, the originator of a telephone call cannot modify the ringtone or other signal annunciated at the called station. The user or owner of the called station has sole control over which ringtones or other signals annunciated for each incoming caller. More importantly, the presentation of the ringtone or other signal (e.g., its volume, pitch, timbre, speed, etc.) is also completely controlled by the called station.

Since individuals may learn to associate certain sounds or visual representation with specific meanings, it would be advantageous if a calling party could modify, augment, or supplement the presentation of a ringtone or other signal about to be annunciated at a called station. For example, sounds often cue certain human reactions. When a driver hears the sound of an ambulance or police siren, the driver typically pulls over to the side of the road automatically. Similarly, the possibility exists to utilize certain sounds and messages to indicate or suggest information about an incoming call or caller before the call is answered.

Thus, it would be advantageous if users could associate a status indication with an outgoing call so that the outgoing call carries some signal indicative of the urgency or importance of the call. It would also be advantageous if a calling party could associate a status indication with an outgoing call that conveys the calling party's moods, thoughts, needs, states of mind, or any other qualities. Users at called communications station may then learn to associate certain ringtone or other signal augmentations, modifications, or supplementations with particular messages, cues, or information. Thus, a seamless system is needed for efficiently typing an outgoing call and utilizing this type to augment, modify, or supplement a ringtone or other signal annunciated on a called communications station.

### SUMMARY OF THE INVENTION

One object of the present invention is to personalize an outgoing telephone call by augmenting, modifying, or supplementing the ringtone or other signal annunciated on the called party's communications station upon receipt of the call.

Another object of the present invention is to provide a system and method for users of wireless communications devices to signal call recipients regarding the importance of an incoming call or the content of the call, or to communicate a calling party's moods, thoughts, needs, or states of mind.

The present invention is also directed to a system and method of augmenting, modifying, or supplementing a selected ringtone or other signal by altering its acoustic properties or by inserting a musical or tonal prelude, preamble, overtone, or undertone to the ringtone or other signal.

Another object of the present invention is to provide a system and method for conveying a caller-specified message visually by displaying the message on the display screen of the called party's communications device.

Yet another object of the invention is to provide a system and method by which users may further personalize their calling experience.

The present invention makes use of call types, or status indications, to further classify an outgoing call from a communications station. These call types and classifications may be used at a called station to augment, modify, or supplement the way ringtones or other signals are annunciated on the called station. The present invention may also make use of custom messages and announcements defined by a calling party in order to personalize the manner in which ringtones or other signals are annunciated on a called station.

### BRIEF DESCRIPTION OF THE DRAWINGS

A further understanding of the present invention can be obtained by reference to a preferred embodiment as set forth in the illustrations of the accompanying drawings. Although the illustrated embodiment is merely exemplary of systems for carrying out the present invention, both the organization and method of operation of the invention, in general, together with further objectives and advantages thereof, may be more easily understood by reference to the drawings and the following description. The drawings are not intended to limit the scope of this invention, which is set forth with particularity in the claims as appended or as subsequently amended, but merely to clarify and exemplify the specific methods and instrumentalities disclosed.

For a more complete understanding of the present invention, reference is now made to the following drawings in which:

FIG. 1 is a schematic cellular network diagram illustrating mobile wireless stations in accordance with one embodiment of the present invention;

FIG. 2 is a functional block diagram of a calling communications station in accordance with one embodiment of the present invention;

FIG. 3 is a functional block diagram of a called communications station in accordance with one embodiment of the present invention;

FIG. 4 is a flowchart illustrating the interaction between a calling party and the present invention-in order to associate a status indication with an outgoing call; and

FIG. 5 is a screen shot of a wireless station's display unit illustrating icons designated to status indication signal types in accordance with one embodiment of the present invention.

### DETAILED DESCRIPTION OF THE PREFERRED EMBODIMENTS

A detailed illustrative embodiment of the present invention is disclosed herein. However, techniques, systems, and operating structures in accordance with the present invention may be embodied in a wide variety of forms and modes, some of which may be quite different from those in the disclosed embodiment. Consequently, the specific structural and functional details disclosed herein are merely representative, yet in that regard, they are deemed to afford the best embodiment for the purposes of disclosure and to provide a basis for the claims herein, which define the scope of the present invention. The following presents a detailed description of a preferred embodiment (as well as some alternative embodiments) of the present invention.

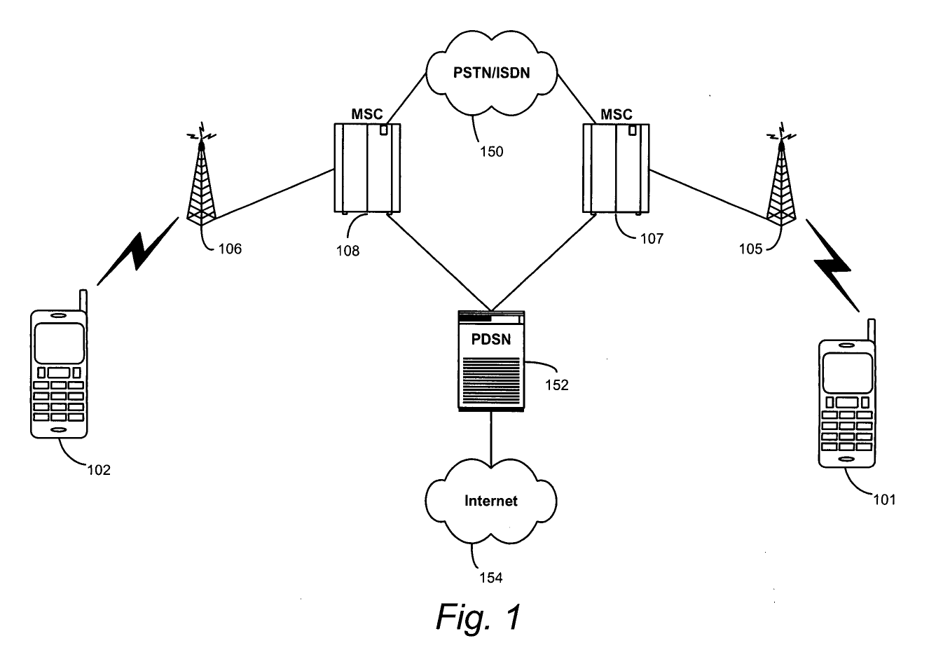

Referring to the drawings wherein like numerals indicate like elements throughout, there is shown in FIG. 1 a schematic diagram of a cellular network comprising mobile wireless communications stations 102 and 101. As is well known in the art, when a user of first wireless station 102 initiates a call, a connection is formed with first base station 106. First base station 106 may be any radio transmitter responsible for serving wireless calls originating from within a cell, or a local geographic area. For example, first base station 106 may serve local wireless calls within a few kilometer radius of first base station 106. As is also common in the art, these cells may be grouped together to form cell clusters.

All base stations within a cell cluster may be connected to a Mobile Switching Center (MSC); typically this connection to the MSC uses land lines. First MSC 108, which handles calls from first base station 106 (and hence calls from first wireless station 102), may be connected to the Public Switched Telephone Network (PSTN) or Integrated Services Digital Network (ISDN) main switching center 150. Switching center 150 may comprise a network control point, network controller, or communications network traffic switching and control mechanism, such as a central office or premises-based audio, data, video, or hybrid switch, a packet switch, or Asynchronous Transfer Mode (ATM) switch, or any associated signaling network control point, service control point, or service switching point or system which routes, monitors, and/or handles and controls calls over a communications network.

First MSC 108 may also be connected to Packet Data Serving Node (PDSN) 152. PDSN 152 may provide access to Internet 154, intranets, and application servers for mobile stations. Acting as an access gateway, PSDN 152 may also provide simple Internet Protocol (IP) and mobile IP access, foreign agent support, and packet transport for virtual private networking.

Similar to first MSC 108, second MSC 107 is connected to second base station 105. Second base station 105 may be responsible for handling wireless calls made from second wireless station 101. Second base station 105 may be any radio transmitter responsible for serving wireless calls originating from within a cell, or a local geographic area. For example, second base station 105 may serve local wireless calls within a few kilometer radius of second base station 105. Second MSC 107 may be connected to the Public Switched Telephone Network (PSTN) or Integrated Services Digital Network (ISDN) main switching center 150. Additionally, second MSC 107 may also be connected to Packet Data Serving Node (PDSN) 152 providing access to Internet 154, intranets, and application servers for mobile stations.

It should also be appreciated that the present invention is not limited to traditional cellular networks (for example, CDMA, PCS, GSM, or the like). With the evolution of enhanced services and the convergence of telephony with data interfaces, today's communications networks are increasingly merging with standard Internet protocols for signaling and media. It is now common in the art for some of these networks to allow for the separation of the signaling from the media transport. For example, an increasing number of Competitive Local Exchange Carriers (CLECs) and Internet Telephony Service Providers (ITSPs) are offering such services as local and long distance telephony, Voice over IP (VoIP), presence and instant messaging, push-to-talk, rich media conferencing, and more, based on Session Initiation Protocol (SIP). Unlike traditional telephone networks, users of SIP-based networks can locate and contact one another regardless of media content and the number of participants.

The present invention is designed for use with any type of communications network including any network capable of transmitting voice, data, video, multimedia, real time, store and forward, interactive, hybrid types of information, or other similar information services. The communications network may be provided by a private or publicly-owned local exchange, interexchange, long distance, international, telecommunications, cable television, broadcast, switched, dedicated, wireless, Voice over IP, Wi-Fi, WiMAX, hybrid types of network providers, or other like networks. The communications network provided by these network providers may utilize wireless, facilities-based, satellite-based, hybrid types of transmission schemes and/or mechanisms, or other systems of similar function.

For the sake of brevity and simplicity, wireless communication stations 102 and 101 of the invention illustrated in the figures are specifically directed to a traditional wireless communications stations used for providing voice communication between two individual network addresses or telephone numbers (e.g., in the present embodiment, these network addresses or telephone numbers correlate to wireless communication stations or telephone stations). However, it should be clearly understood by those skilled in the art from this disclosure that the present invention is not limited to access from such standard wireless communication stations or to telephone station communications systems. In addition, while in the described embodiment one or both of the wireless communication stations 102 and 101 are illustrated as being typical or standard telephone instruments, the terms “station” and “handset” could refer to any device or object which may be connected to or be an integral part of a communications network. A communications network may allow for the initiation, receipt and/or interaction of audio and/or visual information. This information may include voice, data, video, multimedia, real-time, store and forward, interactive or hybrid types of information. It should also be clearly understood that the terms “station” and “handset” should be read to include, but not be limited to, devices such as wireless or cellular telephones, personal digital assistants, digital personal organizers, televisions, video monitors, video telephones, computers, television set-top converters, modems, video servers, front end processors, other communications networks, and combinations or hybrids thereof.

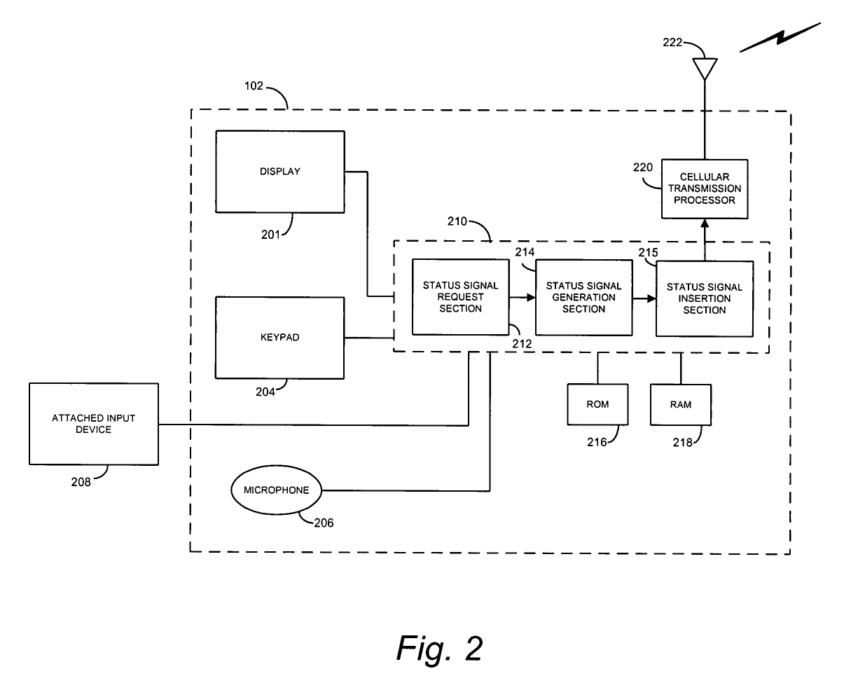

Now referring to FIG. 2, a functional block diagram of a calling wireless station 102 is depicted according to one embodiment of the present invention. Calling wireless station 102 is capable of initiating a call over a wireless communications network described in FIG. 1. Input from a user of calling wireless station 102 may be obtained from at least four sources: display 201, keypad 204, microphone 206, and attached input device 208. A user of calling wireless station 102 may utilize one or more of these user input mechanisms, or any other input mechanism available by calling wireless station 102, to interact with the present invention. As is common in the art, display 201 may comprise soft keys or touch buttons so that a user may touch or tap display 201 to input data or facilitate selections. Similarly, keys or buttons situated within keypad 204 may be pressed by a user of calling wireless station 102 to facilitate data entry. Microphone 206 may be utilized by a user of calling wireless station 102 to facilitate voice-activated input via voice recognition. As is common in the art, by speaking predetermined voice commands translated to common phonemes, a user of calling wireless station 102 may navigate displays, dial telephone numbers or network addresses, input data, execute application, and more. Attached input device 208 could also be utilized as an input mechanism. Attached input device 208 could be connected to calling wireless station 102 by wire or via a wireless data link, such as via Infrared (IR), Bluetooth, Wi-Fi, or other similar network connection. Attached input device 208 may comprise a standard keypad similar to 204, display 201, microphone 206 or comprise any device capable of being attached, connected, or in communication with calling wireless station 102. Examples of attached input device 208 may include, but are not limited to, custom keypads, wired and wireless mice, trackballs, smart pads, electronic tablets, barcode scanners, magnetic strip readers, RFID sensors, fingerprint and retinal scanners, or any other sensor, scanner, recognition unit or input device.

The above input mechanisms are in communication with status signal addition section 210. The status signal addition section 210 allows the calling user at the calling wireless station 102 to choose a desired status type which is later discussed in greater detail. Status signal addition section 210 comprises status signal request section 212, status signal generation section 214, and status signal insertion section 215. Status signal addition section 210 may also be connected to ROM 216 and/or RAM 218 for local memory access. Status signal addition section 210 may achieve its functions through cooperation among the processing means (not shown), ROM 216, and/or RAM 218 located within calling wireless station 102. Status signal request section 212 determines if an outgoing call should be delivered with a particular status indication. Simple logic within status signal request section 212 may make this determination through user interactions with calling wireless station 102, preferences, options, qualification rules stored within memory comprising RAM 218 or ROM 216 or via a network service or data obtained from a network location, server, gateway, or processor accessible by calling wireless station 102.

Status signal generation section 214 may incorporate the status signal request from status signal request section 212 to generate a status indication signal. This signal may indicate the designated status type for the outgoing call. The status indication signal may additionally comprise other information, such as the ringtone or other signal augmentation, modification, or supplementation method desired, the ringtone or other signal to be augmented, modified, or supplemented, the actual augmentation, modification, or supplementation data (e.g., a short prelude, undertone, overtone, etc.), a message to be delivered to a called station upon augmentation, modification, or supplementation, or any other data, including, but not limited to, audio, video, or graphics.

Depending on the communications network, the status indication signal generated by status signal generation section 214 may be inserted via status signal insertion section 215 within standard call signaling messages, delivered via out-of-band signaling, sent over a peripheral channel, or transferred via any network service, messaging protocol, or transmission mechanism accessible by calling station 102. Status signal insertion section 215 transmits this signal to cellular transmission processor 220. Cellular transmission processor 220 may convert the status indication signal into a radio signal to be transmitted by antenna 222. Depending on the communications network, cellular transmission processor 220 may convert the signal to analog form or modulate the signal for transmission, or cellular transmission processor 220 may package the signal for direct transmission over a packet-based network, such as the case for VoIP transmissions.

The status indication signal may be transmitted in various ways. For example, in the preferred embodiment, in-band control channel signaling is used to transmit the status indication signal. However, any transmission method is within the scope of the present invention, including, but not limited to, transmission via in-band signaling messages, out-of-band signaling messages, voice, data, or control channel signaling messages, SIP signaling messages, Q.931 signaling messages, packet headers, packet payload data, SMS, EMS, MMS, or any similar service, etc. In addition, the status indication signal may be transmitted prior to, during, along with, or after the transmission of any call setup or call voice data information.

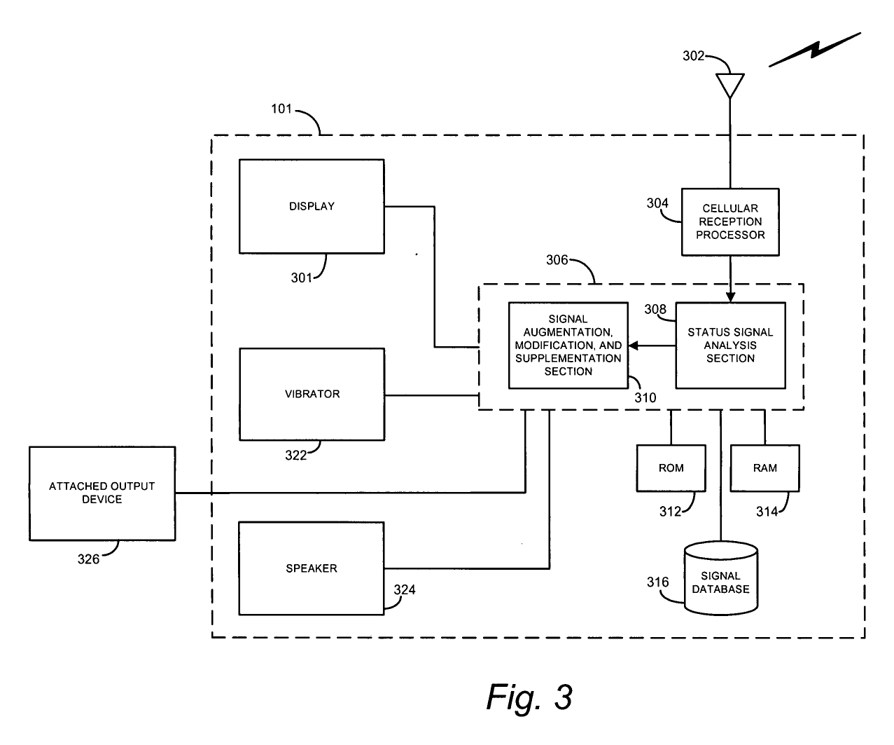

Now referring to FIG. 3, a functional block diagram of a called wireless station 101 is depicted according to one embodiment of the present invention. Called wireless station 101 is capable of receiving a call over a wireless communications network. Output from called wireless station 101 may be obtained from at least four sources: display 301, vibrator 322, speaker 324, and attached output device 326. As is common in the art, called wireless station 101 comprises integrated display 301. Display 301 may include an LCD display, plasma display, matrix display, flat panel display, CRT display, video projection system, or any other system or device capable of displaying visual information. Vibrator 322 may cause called wireless station 101 to pulse or vibrate in any convenient manner. Speaker 324 may be used to sound audio or musical tones and alerts. It is contemplated that speaker 324 and display 301 may be the primary sources of signal annunciation; however, any human perceivable output mechanisms may be utilized, including the above mentioned output devices, attached output device 326, and any backlights within or attached to called wireless station 101.

The above output mechanisms are in communication with status signal processing section 306. Status signal processing section 306 comprises status signal analysis section 308 and signal augmentation, modification, and supplementation section 310. Status signal processing section 306 may also be connected to ROM 312 and/or RAM 314 for local memory access. Status signal processing section 306 may achieve its functions through cooperation among the processing means (not shown), ROM 312, RAM 315, and/or signal database 316 located within called station 101.

Antenna 302 is capable of receiving radio signals from the communications network. Cellular reception processor 304 may modulate or convert the received radio signal for processing by status signal analysis section 308. Status signal analysis section 308 may parse the received signal for its status indication signal, if one exists. Depending on the network, setup, messaging, control, data, or voice channels may be analyzed by status signal analysis section 308 for the status indication signal. Other information may also be parsed, including the signal augmentation, modification, or supplementation method desired, the signal to be augmented, modified, or supplemented, the actual augmentation, modification, and supplementation data (e.g., a short prelude, undertone, overtone, etc.), a message to be delivered to a called station upon augmentation, modification, or supplementation, or any other data, including, but not limited to, audio, video, or graphics.

Once status signal analysis section 308 locates the desired status indication signal, if any, this signal is passed to signal augmentation, modification, or supplementation section 310. As is common in the art, the user of called wireless station 101 may have associated specific signals such as, but not limited to, ringtones, truetones, ringback tones, vibration modes, backlight modes, service light modes, other light modes, video clips, images, text messages, and the like, with certain network addresses or telephone numbers. Signal associations may be based on other factors as well, including the time of day, day of week, calling area code, and calling network address prefix, suffix, etc. Signal augmentation, modification, or supplementation section 310 may perform at least two functions. First, signal augmentation, modification, or supplementation section 310 determines the appropriate signal to annunciate on called station 101. This determination may be made using data stored in signal database 316, ROM 312, and/or RAM 314. In addition, a network storage location, server, or device may be contacted to determine or download the appropriate ringtone or other signal to called station 101. The ringtone or other signal may then be digitally processed or analyzed by signal augmentation, modification, and supplementation section 310 to ascertain its properties.

After signal augmentation, modification, and supplementation section 310 determines the correct signal to annunciate, signal augmentation, modification, and supplementation section 310 then determines the appropriate signal augmentation, modification, or supplementation. Using data from status signal analysis section 308, signal augmentation, modification, and supplementation section 310 then augments, modifies, or supplements the ringtone or other signal associated with the incoming call. The type of augmentation, modification, or supplementation desired may be specified within the status indication signal transmitted by calling station 102 or called station 101 may contain a list of augmentation, modification, or supplementation schemes. This list may be stored locally within called station 101 or on a network location, server, or device and the status indication signal can actuate a particular augmentation, modification, or supplementation scheme.

This augmentation, modification, supplementation may also convey signals in the form of message to the user of called station 101. A digital signal processing (DSP) unit, audio processing unit, voice processing unit, and various audio and video filters (not shown) may also be accessible by signal augmentation, modification, and supplementation section 310 for advanced signal processing capabilities. Signal augmentation, modification, and supplementation section 310 utilizes any available output means, including, but not limited to, display 103, vibrator 322, speaker 324, and attached output device 326, to display, sound, or otherwise annunciate the augmented, modified, or supplemented signal. The augmented, modified, or supplemented signal may optionally be cached or stored within called station 101, ROM 312, RAM 314, or signal database 316 for future use.

Augmentation, modification, or supplementation of a signal in accordance with the present invention can take many forms. Ringtone augmentation may include, for example, inserting a preamble into the ringtone comprising a series of tones or voice data suggestive of the urgency or importance of the call. Ringtone modification may include, modifying the acoustic properties of the ringtone itself, such as its timbre, pitch, volume, or speed at which the ringtone is played. Ringtone augmentation, as defined in the present invention, may further comprise the playing of an undertone or overtone during at least a portion of the ringtone or transitioning from another tone to the associated ringtone. It should be clearly understood that many other forms of ringtone augmentation exist that are within the scope of this invention. Other signal augmentation, modification, and supplementation are performed in a similar manner. Vibration mode modification may include changing the pulses and speeds of the vibration mechanism. Video clips may supplement any set signal signals for the calling party, and so forth.

In accordance with the preferred embodiment of the present invention, several different status indication signal types are utilized. The status indication signals types may be contained in a list of augmented schemes ready to use. Of course, status indication signal types may be defined, redefined, added, modified, and deleted as desired by the user of called wireless station 101, the user of calling wireless station 102, the network service provider, or a third party contracted to provide ringtone services to called station 101.

For example, a call typed as “important” may be associated with a ringtone played or wireless station vibrated at double the normal speed. The playing of the ringtone or vibrating the wireless station at twice its normal speed may signal to the user of called wireless station 101 that the call is more important than a call not typed “important.” An “urgent” call may cause the wireless signal backlight mode to be augmented by successive bursts and appear red in color, looking similar to an ambulance lights. These bursts may suggest to the user of called station 101 that this call should be answered right away. The “informational” status type is defined for telemarketers and other non-essential calls. The ringtones annunciated for these calls may comprise a conventional “ring, ring” undertone throughout the entirety of the designated ringtone. This may cue to the user of called station 101 that this call may be safely ignored if the user is busy or occupied.

Ringtones or other signals for calls typed as “personal” can include a short preamble or prelude. This preamble may contain spoken voice or text identifying the call as personal. Calling parties may also supply their name, association, or a short message to be included within the preamble (e.g., “your boss, Mr. Smith”). This information may identify the content of the incoming call, the calling party, or any other user-supplied or system-derived information. For example, incoming calls typed as “happy,” may cause the associated ringtone to be played at one octave above the ringtone's customary octave, whereas calls typed as “sad” may be annunciated at one octave below the ringtone's customary octave. Finally, calls designated as “confidential” may cause the appropriate ringtone to be played at one-half its normal speed. The playing of the ringtone at a slower speed than usual may be used to cue the user of called station 101 that the incoming call is private. Of course, the above status indication signals are exemplary only. Other status signals and signal augmentations, modifications, or supplementations are within the scope of the present invention and these status types and corresponding signal augmentations, modifications, or supplementations may be user, system, caller, or third-party defined.

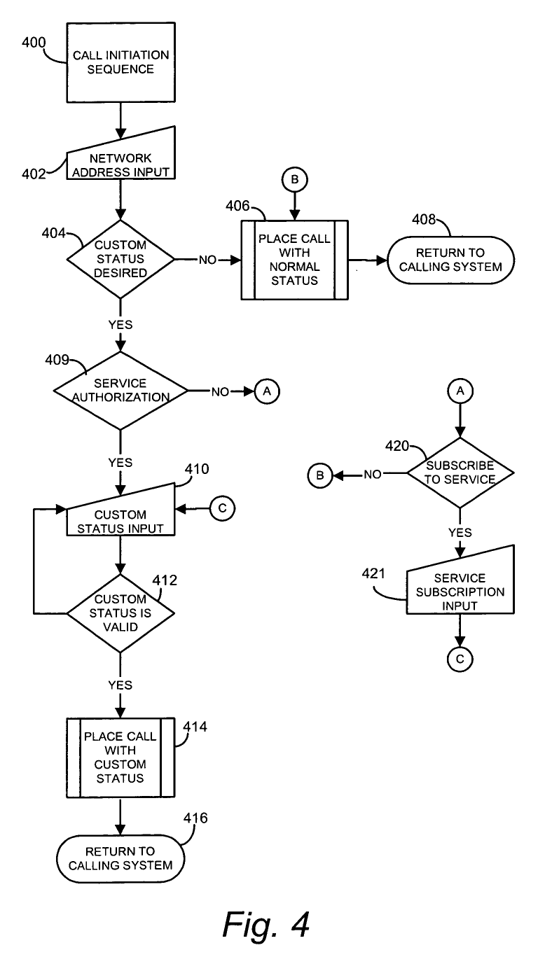

Now referring to FIG. 4, the interaction between a calling party at calling wireless station 102 and the present invention is shown. In one preferred embodiment, the user initiates a call at call initiation sequence 400. The user is then brought to network address input 402 where the user inputs the desired network address or telephone number to be called. Next, the user decides to activate the ringtone and other signal augmentation, modification, and supplementation system if a custom status indication signal is desired at custom status desired stage 404. The user may utilize a special function key, key sequence, soft key, hard key, or voice recognition to access the system. If no custom status is desired, predefined sequence 406 is executed to place the call with no status (or a normal status, as appropriate). The user is then returned to the calling system at exit stage 408 to continue processing the outgoing call. It should be clearly understood by anyone skilled in the art that the caller may first access and initiate the signal augmentation, modification, or supplementation system before imputing the network address or telephone number to be called.

In one preferred embodiment, if a custom status is desired, the user arrives at service authorization 409. Authorization routine validates and confirms support for the ringtone or other signal augmentation, modification, or supplementation service. For example, if the user is not currently authorized to use the ringtone or other signal augmentation, modification, or supplementation system, the user may be given the option to subscribe to the ringtone or other signal augmentation, modification, or supplementation service at stage 420. If the user is unauthorized, the authorization routine prompts the user to verify or confirm that subscription to the ringtone or other signal augmentation, modification, or supplementation service is desired. If subscription to the service is requested, the user may be required to input billing information or personal identifying information, such as a password, PIN, or social security or account number in service subscription input stage 421, in order to complete subscription to the ringtone or other signal augmentation, modification, or supplementation service. Data is provided to the system through hard, soft, attachable, or touch keys, or via voice recognition.

In addition, if the user's account is determined to be presently delinquent, the authorization stage requests the user to provide immediate payment information in order to bring the user's account into good standing. This may be achieved by authorizing an automatic one-time debit of the user's credit or checking account linked with the user's account, or by presenting the user with an input screen so that the user might type, touch, or speak the user's billing information into the system.

Otherwise, if no subscription to the service requested, predefined sequence 406 is executed to place the call with no status and the user is returned to the calling system at exit stage 408 to continue processing the outgoing call. An authorized user or a user who has presently become authorized or subscribed inputs a custom status desired at custom status input 410.

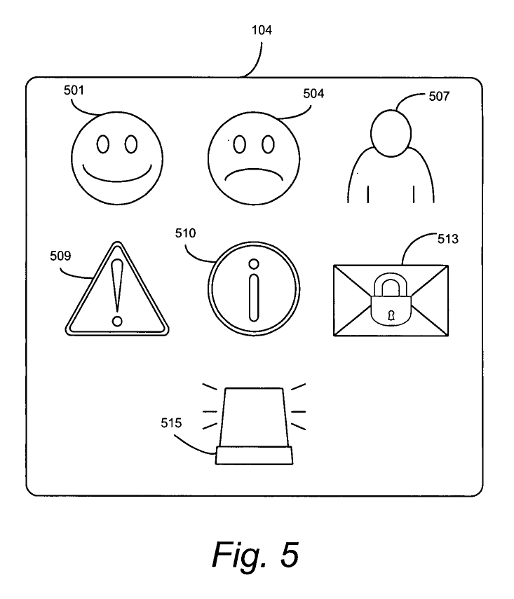

In the preferred embodiment, small graphics (such as icons, smiley faces, etc.) may be associated with certain call status types. FIG. 5 illustrates an example of a menu appears on the wireless station's display unit 104 of call types for the user to quickly touch, speak, or type the call status type into custom status input 510. For example, a siren icon 509 may designate an “urgent” status; an exclamation mark icon 509 may designate the “important” status; an “i” icon 510 for the “informational” status; a person icon 507 for the “personal” status; a smiley face icon 501 for the “happy” status; a sad face icon 504 for the “sad” status; and a locked letter icon 513 for the “confidential” status.

In another embodiment, the user presses a number on the calling station's keypad corresponding to the desired call status. For example, the user may press the number “1” for the “urgent” status; “2” for the “important” status; “3” for the “informational” status; “4” for the “personal” status; “5” for the “happy” status; “6” for the “sad” status; and “7” for the “confidential” status. In another embodiment, at custom status input 410 the user presses a touch button on the communication station's display corresponding to the desired status type. In yet another embodiment, the user speaks the desired status, at which time a voice recognition module automatically selects the spoken status.

In other embodiments, custom status input 410 is automatically pre-populated by the system. In these embodiments, the system determines the status to be associated with the outgoing call based on the inputted network address to call, the time of day, the location of the calling communications station, and any other system-derived information. For example, if the system determines that the communications station is presently calling from a police station or hospital (as determined either by the network address of the calling party or its location as determined via GPS or any other location method), the “urgent” status may be selected by the system. A user or system created automatic selection table may be used to facilitate pre-population of custom status input 410. This table may be stored on the calling communications station, on a network storage device, or on a third-party storage device accessible by the calling station. Other automatic selections schemes are also expressly contemplated. For example, a calling party may configure the automatic selection table to include an entry for all outgoing calls corresponding to a spouse's network address or telephone number. This entry may cause custom status input 410 to automatically designate the “personal” call type for all outgoing calls to this network address or telephone number. Other automatic call type selection strategies will be readily apparent to those skilled in the art. Pre-population of custom status input 410 may allow for seamless, automatic, and invisible integration of the present system with a communications station.

At custom status input 410 the user may additionally define other parameters, such as the signal augmentation, modification, or supplementation method desired, the signal to be augmented, modified, or supplemented, the actual augmentation, modification, or supplementation data (e.g., a short prelude, undertone, overtone, vibration speed, backlight color, etc.), a message signal to be delivered to a called station upon augmentation, or any other data, including, but not limited to, audio, video, or graphics. These settings will serve to override settings at the called station. For example, a calling party may choose to specify a custom image, such as a photograph of the calling party user, to be delivered to the called party for use and be displayed on the called party's display unit. This image will serve to override any ringtone or other signals already established by the called party for the calling party call. As another example, a short text message may be inputted at custom status input 410 so that this message is delivered and displayed to the called party upon receipt of this incoming call. As yet another example, the user may record a short audio clip at custom status input 410 to be delivered with the status indication signal. This audio clip, for example, may comprise the calling party's name or association to the called party and may be annunciated on the called communications station upon receipt of the call as a preamble, overtone, undertone, etc. Other optional parameters may also be specified at custom status input 410 without departing from the spirit of the present invention.

The custom status is validated at validation stage 412. If the status is determined to be invalid, the user is returned to custom status input 410 until a valid status in entered. Otherwise, the call is placed with the custom status and settings at predefined sequence 414. The user is returned to the calling system at exit stage 416 to continue processing the outgoing call.

From the foregoing description of the preferred embodiments, which embodiments have been set forth in considerable detail for the purpose of making a complete disclosure of the present invention, it can be seen that the present invention comprises a system and method for a calling party to augment, modify, or supplement a ringtone or other signal annunciated on a called station. It will be appreciated by those skilled in the art that changes could be made to the embodiment described above without departing from the broad inventive concept thereof. It is understood, therefore, that this invention is not limited to the particular embodiment disclosed, but it is intended to cover all modifications that are within the scope and spirit of the invention as defined by the appended claims.

What is claimed is:

1. A system for augmenting, modifying, or supplementing a signal annunciated on a called station, the system comprising:
a first calling communications station for initiating an outgoing call associated with at least one call type designation;
a second called communications station;
an annunciating signal to be annunciated on said second called communication station in response to the receipt of said call; and
a signal processing module associated with said second called communications station for determining said call type designation of said call;
wherein said annunciating signal is augmented, modified, or supplemented as the result of said call type designation determination.

2. The system of claim 1 wherein said annunciating signal comprises at least one selected from a group consisting of ringtone, ringback tones, vibration modes, backlight mode, service light modes, other light modes, music, sound effect, at least one spoken word, video clip, and multimedia.

3. The system of claim 1 wherein said augmentation, modification, or supplementation comprises at least one selected from a group consisting of ringtone, ringback tones, vibration modes, backlight mode, service light modes, other light modes, music, sound effect, at least one spoken word, video clip, and multimedia.

4. The system of claim 1 wherein said call type designation comprises can be chosen on said first calling communications station from a menu.

5. The system of claim 4 wherein said menu comprises call type designation icons.

6. The system of claim 1 wherein said call type designation is indicative of the importance, urgency, or content of the call.

7. The system of claim 1 wherein said call type designation is indicative of the moods, thoughts, or states of mind of at least one user of said first calling communications station.

8. The system of claim 1 wherein said call type designation comprises a caller-specified message.

9. The system of claim 5 wherein said caller-specified message is indicative of the content of said call.

10. The system of claim 5 wherein said caller-specified message is annunciated on said second called communications station.

11. The system of claim 1 wherein said call type designation is established by at least one user of said first calling communications station.

12. The system of claim 1 wherein said call type designation is established automatically.

13. The system of claim 1 where said augmentation, modification, or supplementation comprises altering at least one acoustic property of said signal.

14. The system of claim 10 wherein said at least one acoustic property is selected from the list consisting of timbre, pitch, loudness, amplitude, and intensity.

15. The system of claim 1 wherein said augmentation, modification, or supplementation comprises at least one selected from a group consisting of altering the speed of annunciation of said annunciating signal, incorporating an undertone or overtone into said annunciating signal, and annunciating a preamble before said annunciating signal.

16. A method for augmenting, modifying, or supplementing a signal annunciated on a called station, the method comprising the step of:
associating, at a calling communications station, at least one call type designation;
modifying at least a portion of a call signal to include data indicative of said call type designation;
receiving, by a called communications station, said call signal;
selecting an annunciating signal to be annunciated in response to the receipt of said call signal; and
augmenting said annunciating signal based on said call type designation.

17. The method of claim 16 wherein said call type designation is established by at least one user of said calling communications station.

18. The method of claim 16 wherein said call type designation is established automatically.

19. The method of claim 16 where said augmentation comprises altering at least one acoustic property of said annunciating signal.

20. The method of claim 19 wherein said at least one acoustic property is selected from the list consisting of timbre, pitch, loudness, amplitude, and intensity.

21. The method of claim 16 where said augmentation comprises at least one selected from a group consisting of altering the speed of annunciation of said annunciating signal, incorporating an undertone or overtone into said annunciating signal, and annunciating a preamble before said annunciating signal.
